(19) United States
(12) Patent Application Publication
(10) Pub. No.: US 2003/0061612 A1
(43) Pub. Date: Mar. 27, 2003

(54) Key frame-based video summary system

(75) Inventors: Jin Soo Lee, Seoul (KR); Heon Jun Kim, Gyeonggi-do (KR)

Correspondence Address: JONATHAN Y. KANG, ESQ., LEE & HONG P.C., 11th Floor, 221 N. Figueroa Street, Los Angeles, CA, 90012-2601, US

(73) Assignee: LG Electronics Inc.

(21) Appl. No.: 10/254,114

(22) Filed: Sep. 25, 2002

(30) Foreign Application Priority Data
Sep. 26, 2001 (KR) 59568/2001

(51) Int. Cl. G06F 3/00; H04N 5/445; G06F 13/00; G09G 5/00

(52) U.S. Cl. 725/61; 725/38; 345/723; 345/838

(57) ABSTRACT

The present invention relates to a video summary system for summarizing a video such that the video can be searched for the purpose of multimedia search and browsing. The present invention is to provide the video summary function based upon effective key frames using the process that is capable of being implemented easily, thereby obtaining an intelligent function at a low cost.

### BACKGROUND OF THE INVENTION

1. Field of the Invention

The present invention relates to a video summary system for summarizing a video such that the video can be searched for the purpose of multimedia search and browsing.

2. Description of the Related Art

As multimedia services such as VOD and Pay Per View are activated via the Internet atmosphere, various video summary technologies are getting presented to provide convenient services to users so that the users can search a video and get summarized information thereof without watching the whole video. The video summary allows a user to more effectively search a desired video or find a desired scene before selecting a video that he/she wants to watch. The video summary technologies may be based upon key frame or summarized display mode.

The video summary technologies based upon key frame show important scenes in the form of key frames to a user so that the user can easily understand the entire video story and readily find a desired scene. In order to realize a video summary based upon key frame, a technique is necessary by which the video can be structurally analyzed. In structural analysis, a basic technique is to divide scenes, i.e. part for discriminating contents. However, it is difficult to automatically analyze and divide the scenes since they function as discriminative parts. Therefore, attempts are getting reported which primarily divides the video into shots as basic editing part and then group the shots so as to discriminate the video similar to the scenes. A number of techniques have been reported which segment the shots. The key frames can be extracted and displayed according to segments discriminated in the part of shot or scene as above in order to summarize the video.

The above-described summary method based upon key frame is very useful for a user to find a desired scene since it simultaneously displays a number of scenes.

However, for the purpose of scanning entire video contents, a method such as highlight is more useful which displays summarized images. This method also adopts shot segmentation or other complicated techniques such as audio analysis. However, those techniques reported up to the present are mainly studies about specific genres of video and thus hardly applicable to general genres of video. Since videos include a number of genres, a video of a specific genre is readily analyzed, summarized, searched and browsed on the basis of information discriminative from other genres of videos.

Recently, as digital TV broadcasting is operated and digital TVs are widely spread, there is an increasing desire to conveniently watch the TV at home by using the above-described video summary technologies. In general, among the video summary technologies for such a watching of television, one is to operate a broadcasting including the summary information when broadcasting companies are broadcasting, and the other is to operate a broadcasting by analyzing an original general broadcasting at a terminal such as TV and automatically extracting the summary information. In the former case, expensive equipments such as broadcasting equipments should be modified, and its realization is delayed rather than would be expected, since these services do not contribute greatly to the broadcasting companies in terms of benefits. In the latter case, there is an attempt to equip terminals such as TV with a processor and a memory used for a video and audio analysis, and to utilize a personal video recorder (hereinafter, referred to as PVR) that can broadcast by temporarily storing a received TV broadcasting in a form of set-top box. Due to restrictions that will be described below, however, the above-described services cannot be obtained.

The first problem is a restriction on a real-time processing.

The PVR provides a function to receive the broadcasting, to simultaneously record the received broadcasting in a digital video format such as MPEG, and to watch again when a user want to. To provide the above-described services in the PVR, the process for these services should be performed simultaneously with the recording since the user does not know when she or he watches broadcasting material that is being recorded. Thus, these processes (video summary process) should be performed in real time simultaneously with an encoder operation of recording images. However, since many processes known up to the present are too complicated, it is very difficult to perform the processes in real time onto software. Therefore, the real time processes can be obtained by implementing many portions with hardware.

The second problem is a price and a manufacturing cost. As described above, when many portions are implemented with hardware so as to perform the video summary process in real time, there is a restriction on the implementation of hardware since the price of personal household electrical appliances such as the PVR should not be high in view of supply and practicality thereof. That is, only the hardware that can be implemented at a lower price and a lower manufacturing cost can make a great contribution to the practicality.

The third problem is a service independent of genres. The services that can secure appropriately effective performance to the user with respect to all broadcastings (various kinds of broadcasting materials) can be provided, because of the services about the broadcasting images. At the present time, since genres information on broadcasting data is not provided, an algorithm used for the video summary should not be developed depending on specific genres.

There is a demand on a method of effectively providing video summary/searching function to all the genres using smaller process that can satisfying the above-described restrictions.

### SUMMARY OF THE INVENTION

Accordingly, the present invention is directed to a key frame-based video summary system that substantially obviates one or more problems due to limitations and disadvantages of the related art.

An object of the present invention is to provide a video summary service that is effect to all genres.

Since the present invention encodes and stores broadcasting data received from a broadcasting data storage system and at the same time has to extract information necessary for a service to be provided, it uses information partially realized by a hardware (H/W) along with information processed by a software.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a video summary system comprising: a broadcasting receiving means for receiving a broadcasting data; a broadcasting data storing means for storing the received broadcasting data; a DC image processing means for extracting a DC image from the stored broadcasting data and storing the extracted DC image; a characteristic information extracting means for extracting a characteristic information necessary for a video summary using the DC image; and a browsing means for servicing the video summary using the extracted characteristic information.

According to another aspect of the present invention, there is provided a method for extracting a key frame comprising the steps of: extracting a frame from a moving picture at a predetermined period; designating the frame among the extracted frames as a candidate of the key frame, the designated frame being one that it is determined that a face appears; if a timing difference of two consecutive candidates of the key frame is over a critical value, adding a part of the extracted frames as the candidate of the key frame; and if the timing difference of two candidates of the key frame is below the critical value, comparing similarities of the two candidates of the key frame and deleting one candidate that is lower in the similarity.

According to a further aspect of the present invention, there is provided a method for extracting a key frame comprising the steps of: extracting a frame from a moving picture on the basis of a shot information at a predetermined period; designating at least one of the extracted frames as a candidate of the key frame, the designated frame being one that it is determined that a face appears; if one candidate of the key frame does not appear in one shot among the designated key frame candidates, designating the key frame candidate among the frames within the shot; and if at least two candidates for the key frame exist in one shot among the designated key frame candidates, selecting only one key frame candidate and designating the selected key frame candidate as the key frame candidate.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram of a broadcasting data storage system of a video summary system according to a first embodiment of the invention;

FIG. 2 is a block diagram illustrating a key frame view according to the video summary system of the invention;

FIG. 3 is a flow chart of a process of extracting a key frame in the video summary system of the invention;

FIG. 4 is a schematic view depicting a method for extracting a facial region in a video summary system according to the present invention;

FIG. 5 is a schematic view depicting a facial region of a color space for extracting the facial region in a video summary system according to the present invention;

FIG. 6 is a schematic view depicting a method for extracting a facial appearance region in a video summary system according to the present invention;

FIG. 7 is a schematic view depicting an exemplary image for illustrating a method for extracting a facial appearance region in a video summary system according to the present invention;

FIG. 8 is a schematic view of a broadcasting data storage system in a video summary system according to a second embodiment of the present invention; and

FIG. 9 is a schematic view depicting a key frame extracting method including a shot information in a video summary system of the present invention.

### DETAILED DESCRIPTION OF THE PREFERRED EMBODIMENT

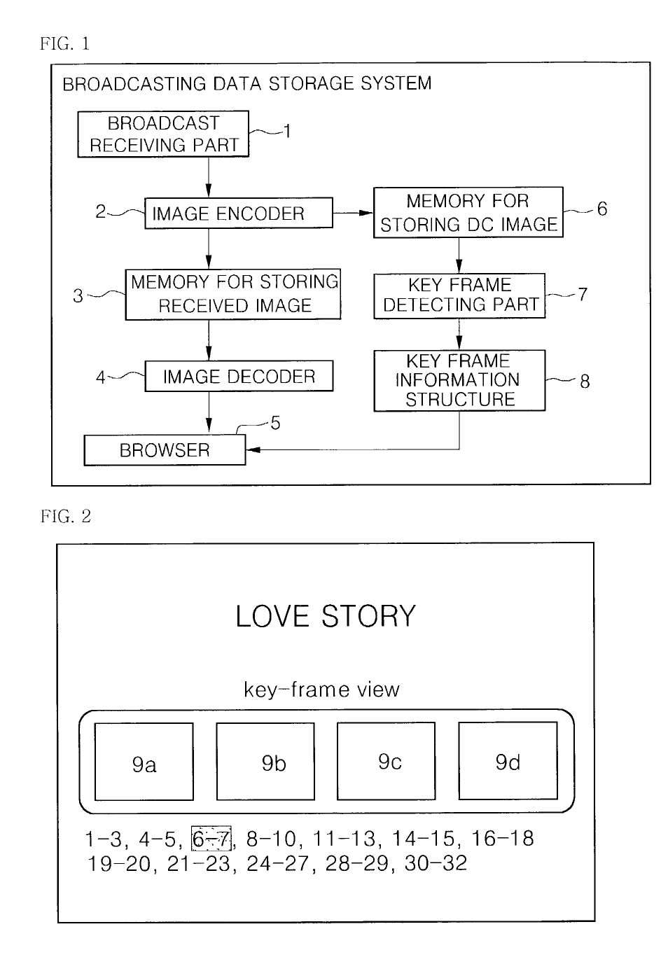

FIG. 1 is a block diagram of a broadcasting data storage system in a video summary system according to a first embodiment of the invention. The broadcasting data storage system includes a broadcast receiving part 1 for receiving broadcasting data, a video encoder 2 for encoding the received broadcasting data, a memory 3 for storing the encoded broadcasting data, a video decoder 4 for decoding the stored broadcasting data, a browser 5 for displaying the decoded broadcasting data and summarizing the same based on a key frame, a DC image storage memory 6 for outputting a DC image during the encoding, a key frame detecting part 7 for extracting the key frame in the form of characteristic information necessary for video summary using the stored DC image, and a key frame information structure 8 for defining the extracted key frame or characteristic information as a defined structure and providing the defined structure to the browser 5 for video summary.

In the broadcasting data storage system shown in FIG. 1, the broadcast receiving part 1 receives an image, the video encoder 2 encodes the image, and the memory 3 stores the encoded received image in the form of MPEG1 or MPEG2. The system utilizes a DCT algorithm in order to encode the received image into a multimedia image of the above format, such as MPEG1 or MPEG2, by which a DC image is obtained. In order to use the DC image as characteristic information extracting data for the purpose of aforementioned video summary, the DC image storage memory 6 temporarily stores the DC image as it is encoded. In this case, the DC image can be stored at every I-type frame.

The key frame detecting part 7 functioning as feature information extracting means fetches any necessary DC image from the DC image storage memory 6 and executes a key frame extracting algorithm for determining a frame to be used as a key frame. The key frame extracting algorithm serves to extract the key frame based upon face regions.

The frame which is determined as the key frame in the multimedia image is stored as a thumbnail image in the key frame memory (which can be included in the key frame detecting part or allocated to an additional memory) for the purpose of display, and the key frame information structure 8 describes position information for indicating the position of the stored thumbnail image and the position of the corresponding key frame in the multimedia image.

After that, if a user requests key frame-based video summary, the video summary browser 4 provides the key frame-based video summary using the above produced key frame information structure 8.

Thus, the method of providing a video summary function merely using the DC image extracted from the received/stored broadcasting data format enables real time processing and is very effective in the costs aspect. FIG. 2 shows a user interface for key frame-based video summary by the way of example representing an interface type which is mainly provided in a DVD. The user interface includes thumbnails 9a to 9d arrayed therein and the user can select one of the key frames on display to directly watch the corresponding image.

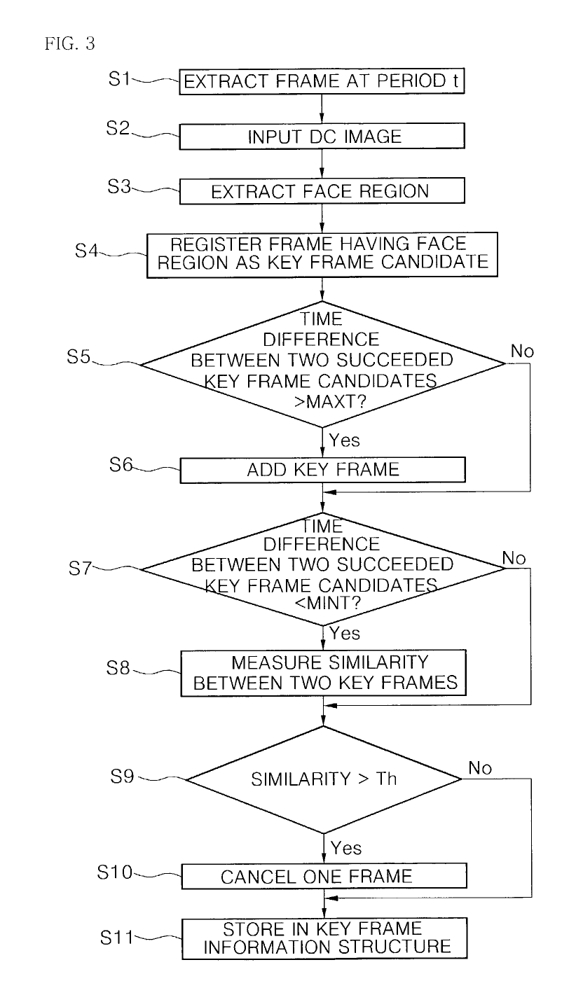

FIG. 3 is a flow chart of a method of extracting a key frame in the video summary system. The key frame extracting method for video summary of the invention includes the steps of: extracting frame in a unit of time, extracting a facial appearance frame, adding a candidate frame, and filtering a candidate frame, in which the steps are described as follows:

1. Step of Extracting Frame in a Unit of Time (S1)

A frame is extracted at a period of a predetermined time t in a multimedia video with respect to I frame. Where the period is t and the entire image has a length of T, frames are extracted as many as T/t, in which T/t will be defined as the number of candidate frames. Necessarily the number of candidate frames is sufficiently larger than that of key frames which will be actually extracted.

2. Step of Extracting Face-appearing Frame (S2 to S4)

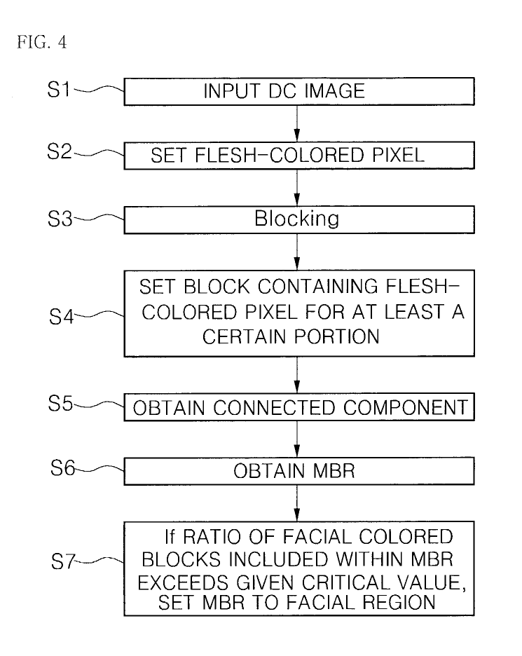

Those frames which it is supposed that face appears among the frames extracted in the step of S1 are nominated as the key frame candidates. That is to say, the face regions are extracted by inputting DC images, and those frames in which the face regions are detected are registered as the key frame candidates (S2 to S4). Only the DC images of the frames extracted in S1 are used to determine an algorithm for discriminating the frames which are supposed to display the face regions, which will be described in detail in reference to FIGS. 4 to 8.

3. Step of Adding Candidate Frame (S5 and S6)

Of the key frame candidates nominated in S4, if the time difference between any two adjacent key frame candidates successive in time sequence is larger than a given critical value maxT, at least one key frame candidate is additionally nominated among the frames, which are extracted in S1 between the two key frame candidates in time sequence, according to the maximum blank time period maxT. That is, the time difference is calculated between the two key frame candidates successive among the key frame candidates nominated in S4, and the difference is compared with given critical value maxT. If the time difference is larger than given critical value maxT, the system further nominates at least one key frame candidate among the frames extracted in S1 between the two key frame candidates in time sequence according to the maximum blank time period maxT. This step serves to forcibly insert key frames for a proper time period in order to prevent absence of the key frames for excessively long time when the face is not displayed for a long time period. The maximum blank time period maxT is determined by experiment.

4. Step of filtering candidate frame (S7 to S11)

The system calculates the time difference between the two key frame candidates successive in time sequence, and compares the time difference with another given critical value minT (S7). If the time difference is smaller than the critical value minT, the system measures the degree of similarity between the two key frame candidates (S8), and compares the degree of similarity with the critical value minT (S9). If the degree of similarity is the critical value or more, the system cancels one of the above-compared two key frames from the key frame candidates (S10), and stores the finally selected key frame into the key frame information structure (S11). In this series of filtering steps, if the time difference between the two key frame candidates successive in time sequence among the key frame candidates produced in the above steps up to S6 is smaller than the given critical value minT, the degree of similarity is compared between the two key frame candidates and one of the key frame candidate is canceled from the key frame candidates if the degree of similarity is the give critical value minT or more.

Where similar characters or scenes appear in a short time interval, this serves to use only one of the two key frames thereby avoiding unnecessary key frame selection. The method of measuring the degree of similarity between the two key frame candidates may adopt either a sub-area color histogram or a whole area color histogram.

The method of measuring the similarity using the sub-area color histogram corresponds to a frame that it is supposed that both faces of the two key frame candidates appear. The method creates a color histogram only with respect to a region other than the extracted face region if the algorithm for determining whether or not the face appears used in the step of extracting the face-appearing frame can extract information of the face regions. That is, the system compares the color histograms about those areas except for the face regions of the two key frame candidates. If the difference between the color histograms is the smaller, the key frame candidates are supposed similar, while, if the difference is the larger, the key frame candidates are judged dissimilar.

The method using the whole area color histogram extracts color histograms from the whole frames and compares the extracted color histograms to measure the degree of similarity in situations except for the above situation, in which one of the key frame candidates is not supposed to display a face region or the algorithm for discriminating appearance of face region used in the face-displaying frame extracting step cannot extract information of the face regions.

According to the method as set forth above in reference to FIG. 3, the key frames are extracted and then stored in the form of thumbnails as described above to be used in key frame based video summary.

In order to analyze one multimedia image, the above extracting method of key frame may sequentially execute the steps (i.e. temporal frame extraction, face-displaying frame extraction, candidate frame addition and candidate frame filtering) with respect to the whole multimedia image. Alternatively the above four steps may be executed with respect to a portion of the multimedia image and then repeated with respect to the next portion thereof. In order to execute a 60 minute video, for example, the video can be continuously analyzed in time sequence thereof by executing the key frame extracting algorithm with respect to every 1 minute image. This method is adequate to execute the above processing while to sequentially record the image, and although the user requests the key frame-based video summary service on the user's way to the recording

The method of judging face appearance as set forth in the extracting step of face displaying frame in FIG. 3 may include a method which extracts facial areas also and another method which judges face appearance only. The former can be applied to the following step of filtering frame candidate to further correctly judge the face appearance. Otherwise the latter advantageously has a simple process. Each of the methods will be described as follows.

FIG. 4 shows a process according to the method of extracting facial area information. First, the following process is executed to all of the frames which are extracted according to the period t described in reference to FIG. 3. The system receives the DC image of the corresponding frame (S1), and sets only facial colored pixel in respect to each pixel of the DC image. The facial colored areas are set 1, but other areas are set 0.

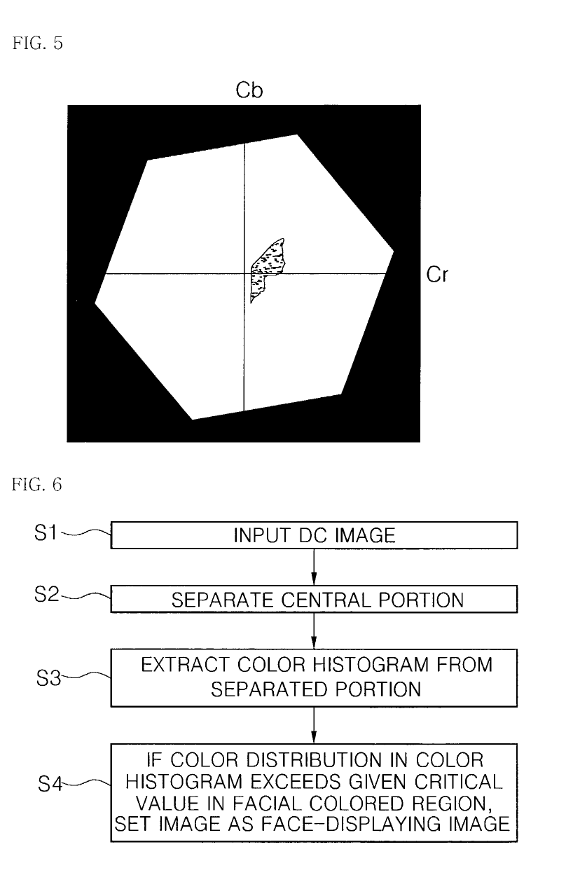

Judgment of facial colored area is executed in a YCrCb colore space in order to directly use color information without change of color space since the DC image of MPEG1 or MPEG2 is expressed in the YCrCb color space. The interval of facial color area in the YCrCb color space is determined according to experiment, in which a method thereof is determined by using a statistical method in a training set which is made by collecting facial color area images. In the YCrCb area, Y indicates information corresponding to brightness in which an interval pertinent to brightness within a given range corresponds to facial color area. The facial color area in CrCb section is dotted in FIG. 5. As can be seen in FIG. 5, in CrCb section, the facial color interval has conditions which can be expressed by four components.

The image in which only the facial colored areas are set 1 is divided into N*M blocks (S3). Then every block is set 1 or 0 according to whether it contains facial color area or not (S4). That is, if a block contains a facial colored pixel in at least a given portion, the corresponding block is set 1. Then it is inspected whether those blocks set to 1 are connected together to judge whether a connected component exists with at least a given size (S5). If the connected component exists, the system obtains Minimum Boundary Rectangle (MBR) (S6). If the ratio of the blocks set 1 exceeds a given critical value in MBR, MBR is supposed a facial region (S7). That is, obtained MBR corresponds to position information of the face.

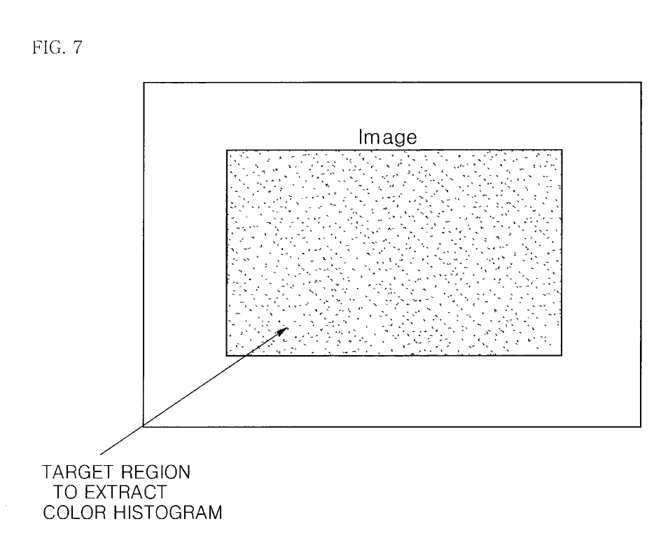

The method of judging appearance of face is executed very simply but its correctness is relatively low. FIG. 6 shows a process according to this method. The following process is executed to all of the frames which are extracted according to the period t as set forth in reference to FIG. 3. First, as shown in FIG. 7, color histogram is obtained from the DC image except for some boundary areas (S1, S2, S3). The areas from which the color histogram is not obtained are determined according to experiment, in which the facial area mainly appears in a central portion. Then the distribution of color shown in the obtained color histogram is inspected, and if an image contains any color corresponding to facial color for at least a given critical value, the image is set as the face-displaying image (S4).

[Embodiment 2]

The first embodiment provides the video summary technology based upon the simple and effective key frame, in which the broadcasting data storage system provides only the DC images with hardware and uses them.

With an additional expense, specific information used to implement shot information or shot extraction module, except for the DC images, with software can be extracted with the hardware.

In this case, by using the shot information additionally to the above-described first embodiment, a video summary service with higher performance can be provided. When the moving picture is constructed by editing image blocks that are continuously captured by a camera, a unit of editing (i.e., the continuous image interval) becomes one shot. These shot is classified by a sudden scene change (i.e., a hard cut), a dissolve (a slow overlapping of two scenes), and other various image effects. The extracting of the specific information with the hardware so as to implement the shot information or the shot extraction module with a software means extracting directly and informing with the hardware a position at which the shot is changed, or extracting with the hardware and outputting needed specific information of a color histogram so as to easily detect the shot change position.

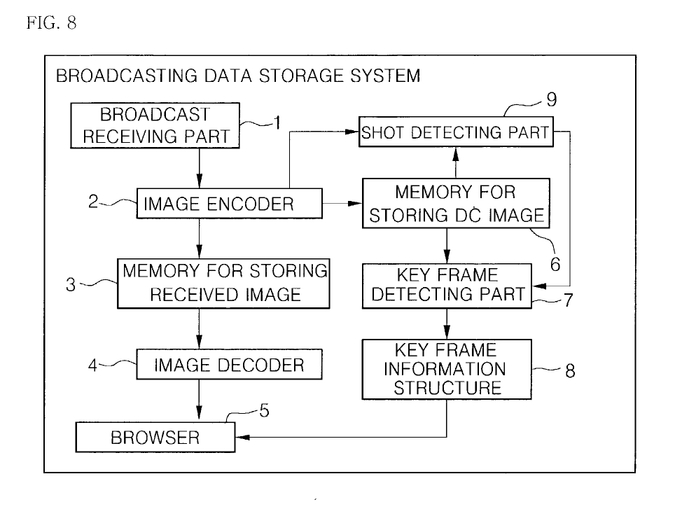

FIG. 8 shows the video summary system including this shot information. The video summary system further includes a shot detecting part 9, and a detected shot information is used in the key frame detecting part 7. As described above, the shot detecting part 9 can directly extract the shot information through the hardware, or it can extract only desired information through the hardware and then detect the shot information through the software by using the extracted information. That is, in the latter case, a module that can extract only specific information for detecting the shot position is implemented with the hardware. Here, the module for detecting the shot position using the specific information for the extracted shot position is implemented with the software. A description of other respective elements shown in FIG. 8 is made in FIG. 1, so that a detailed description will be omitted.

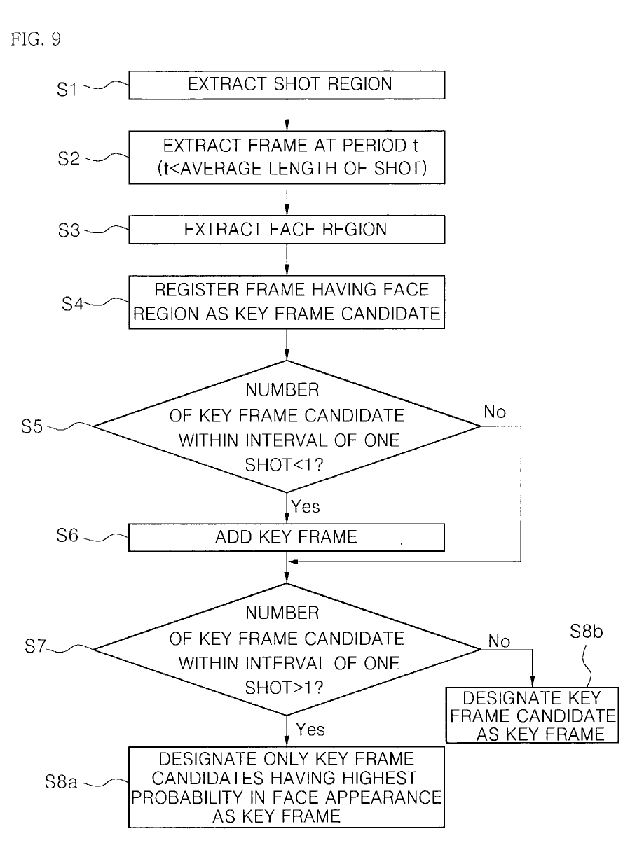

FIG. 9 is an algorithm for extracting a key frame based upon a face region by adding the shot information. The algorithm comprises a step of extracting frame in a unit of time, a step of extracting face-appearing frame, a step of extracting candidate frame, and a step of filtering candidate frame.

1. Step of Extracting Frame in a Unit of Time (S1, S2)

A frame is extracted at a period of a predetermined time t in an inputted image with respect to I frame. The predetermined time t being capable of extracting a plurality of frames within one shot is determined. At this time, in case where a frame has a smaller length than the predetermined time t because the shot is short, one or more frames are compulsorily extracted.

2. Step of Extracting Face-appearing Frame (S3, S4)

Those frames supposed to display face regions are nominated as the key frame candidates among the frames extracted in S1 and S2. An algorithm for discriminating the frames supposed to display the face region is identical to that described in FIG. 4 or FIG. 6.

3. Step of Adding Candidate Frame (S5, S6)

If no frame candidates among the key frame candidates nominated in S4 appears within one shot, one of the extracted key frames in the step of extracting the frame in the unit of time is nominated as a key frame of corresponding shot. This step is performed in order to nominate one key frame to one shot even when the face does not appear. At this time, if the length of the shot is too short, the above-described process can be omitted.

4. Step of Filtering the Candidate Frame (S7, S8a, S8b)

Among the key frame candidates generated via the above steps, if two or more key frame candidates exist within one shot, only the frames having the highest probability in the face appearance are designated as the key frame (S7, S8a). The probability of face appearance can be designated in proportion to a weight at which the facial color is include in the algorithm of extracting the face regions. If one key frame candidate exists within one shot, that key frame candidate is nominated as the key frame (S8b).

The key frames are extracted by the above-described method of extracting the key frame. And then, as describe above, the extracted key frames are stored as the thumbnail and are afterwards used in the video summary based upon the key frame.

Like the first embodiment, respective four steps described in FIG. 9 can be sequentially performed with respect to the entire moving pictures so as to analyze one moving picture. Further, after performing the four steps with respect to only a portion of the video, the steps can be repeatedly performed with respect to only the next portion of the video. For example, the step of extracting the key frame in FIG. 9 is performed, and then a video analysis is continuously performed along the time axis in the way of performing the step of extracting the key frames with respect to the next shot.

In the PVR system with a form of set-top box in which the TV broadcasting program can be recorded and re-watched, the present invention is to provide the video summary function based upon effective key frames using the process that is capable of being implemented easily, thereby obtaining an intelligent function at a low cost. Particularly, the present invention is to provide an effective summary function without regard to the genres of the broadcasting, and to provide a realizable method that can be easily implemented technically.

What is claimed is:

1. A video summary system comprising:
a broadcasting receiving means for receiving a broadcasting data;
a broadcasting data storing means for storing the received broadcasting data;
a DC image processing means for extracting a DC image from the stored broadcasting data and storing the extracted DC image;
a characteristic information extracting means for extracting a characteristic information necessary for a video summary using the DC image; and
a browsing means for servicing the video summary using the extracted characteristic information.

2. The video summary system of claim 1, wherein the extracting of the DC image is performed during encoding for storing the received broadcasting data.

3. The video summary system of claim 1, wherein the characteristic information extracted from the DC image is a key frame-based summary information.

4. The video summary system of claim 1, wherein the characteristic information extracted from the DC image is a key frame-based summary information which is performed by an analysis of a facial color and based on whether or not a facial region appears.

5. The video summary system of claim 1, further comprising a shot detecting means for detecting a shot information to extract the characteristic information.

6. The video summary system of claim 5, wherein the characteristic information extracted from the DC image is a key frame-based summary information.

7. The video summary system of claim 5, wherein the characteristic information extracted from the DC image is a key frame-based summary information which is performed by an analysis of a facial color and based on whether or not a facial region appears.

8. A method for extracting a key frame comprising the steps of:
extracting a frame from a moving picture at a predetermined period;
designating the frame among the extracted frames as a candidate of the key frame, the designated frame being one that it is determined that a face appears;
if a timing difference of two consecutive candidates of the key frame is over a critical value, adding a part of the extracted frames as the candidate of the key frame; and
if the timing difference of two candidates of the key frame is below the critical value, comparing similarities of the two candidates of the key frame and deleting one candidate that is lower in the similarity.

9. The method of claim 8, wherein the frame added when the timing difference of two candidates of the key frame is below the critical value is selected from a part of the extracted frames included in a time period of the critical value of the timing difference and added.

10. The method of claim 8, wherein the step of determining whether or not the face appears is performed by using the DC image on a corresponding frame.

11. The method of claim 8, wherein the step of determining whether or not the face appears comprises the steps of:
sorting only a pixel corresponding to the facial color with respect to the DC image of a corresponding frame;
sectioning the entire area of the DC image into a matrix of N*M and blocking the sectioned DC image;
classifying the block corresponding to the facial color based on a proportion of the pixel having the facial color in each of the blocks;
connecting the blocks of adjacent facial color to obtain a connected component;
obtaining a quadrangle MBR including the connected component; and
extracting a facial region based on a proportion of the facial region.

12. The method of claim 8, wherein the step of determining whether or not the face appears comprises the steps of:
obtaining a color histogram from a DC image of a corresponding frame; and
if the color of the obtained color histogram is concentratedly distributed on the facial color region over a predetermined part, determining that the face appears.

13. The method of claim 8, wherein the step of measuring the similarities of the two key frame candidates is performed by using color histograms of the two frames.

14. The method of claim 8, wherein the step of comparing the similarities of the two key frame candidates is performed through a comparison of a color histogram with respect to the remaining region except for the facial region in each of the frame.

15. A method for extracting a key frame comprising the steps of:
extracting a frame from a moving picture on the basis of a shot information at a predetermined period;
designating at least one of the extracted frames as a candidate of the key frame, the designated frame being one that it is determined that a face appears;
if one candidate of the key frame does not appear in one shot among the designated key frame candidates, designating the key frame candidate among the frames within the shot; and
if at least two candidates for the key frame exist in one shot among the designated key frame candidates, selecting only one key frame candidate and designating the selected key frame candidate as the key frame candidate.

16. The method of claim 15, wherein the step of designating the key frame of when at least two key frame candidates exist designates the key frame candidate which has the highest probability in the face appearance as the key frame.

17. The method of claim 15, wherein the period for extracting the frame is set shorter than an average length of the shot.

18. The method of claim 15, further comprising, if the shot is shorter in length than the period for extracting the frame and the frame is not extracted, extracting a part of the frame belonging to the shot as the frame for designating the key frame candidate.

19. The method of claim 15, wherein the step of of determining whether or not the face appears comprises the steps of:
sorting only a pixel corresponding to the facial color with respect to the DC image of a corresponding frame;
sectioning the entire area of the DC image into a matrix of N*M and blocking the sectioned DC image;
classifying the block corresponding to the facial color based on a proportion of the pixel having the facial color in each of the blocks;
connecting the blocks of adjacent facial color to obtain a connected component;
obtaining a quadrangle MBR including the connected component; and
extracting a facial region based on a proportion of the facial region.

20. The method of claim 15, wherein the step of determining whether or not the face appears comprises the steps of:
obtaining a color histogram from a DC image of a corresponding frame; and
if the color of the obtained color histogram is concentratedly distributed on the facial color region over a predetermined part, determining that the face appears.
